(19) United States
(12) Patent Application Publication
(10) Pub. No.: US 2013/0322218 A1
(43) Pub. Date: Dec. 5, 2013

(54) World Time Timepiece

(71) Applicants: Wolfgang Burkhardt, Ispringen (DE); Roland Burghausen, Niefern (DE); Louis M. Galie, Newtown, CT (US); Siegfried Grau, Pforzheim (DE); Gerhard Stotz, Eisingen (DE)

(72) Inventors: Wolfgang Burkhardt, Ispringen (DE); Roland Burghausen, Niefern (DE); Louis M. Galie, Newtown, CT (US); Siegfried Grau, Pforzheim (DE); Gerhard Stotz, Eisingen (DE)

(21) Appl. No.: 13/482,474

(22) Filed: May 29, 2012

(51) Int. Cl. G04B 19/23

(52) U.S. Cl. 368/22

(57) ABSTRACT

A wearable timepiece having at least one rotateable elongated member, preferably a ring, under the dial, having a plurality of time zone indications thereon, wherein a controller controls the rotation of the at least one elongated member and causes an indicator to rotate in response to a selected time zone indication positioned in a viewing window in the dial, wherein the indicator points to indicia on the dial assembly that indicates to a user the time indicated by the selected time zone indication.

### BACKGROUND OF THE INVENTION

The present invention relates to electronic devices such as timepieces in general and wristwatches in particular, and specifically, to an improved construction and methodology for displaying and conveying the time in different time zones around the world. Most advantageously, the present invention is applicable to timepieces typically referred to as “analog” or “quartz-analog” watches having hands for displaying time. Analog timepieces that indicate the time in different time zones are well known, examples of which can be found in U.S. Pat. Nos. 5,237,544; 5,497,358; 5,499,220; 7,307,916 and 7,742,361, as well as in U.S. Published Application Nos. 2005/0190653; 2006/0239123 and 2010/0067332. However, as discussed below and as would be further understood by those skilled in the art, these prior art constructions all have perceived deficiencies that the present inventors have addressed and overcome. For example, timepieces that have the time zone indicators fixed to the bezel (whereby a hand is provided for pointing to the selected time zone on the bezel) are perceived as being less than optimally desirable for the user. Another perceived drawback are the limitations associated with such timepieces in which there is a meshing engagement between the time zone indication ring and the hour hands, a construction seen in mechanical watches, for example. Another perceived drawback exists even in those mechanical watches that can simultaneously display time in two locations (e.g. a “home” time and a second time), as none of these known watches can enable individualized city/region time zone setting.

Accordingly, it is desirable to provide a timepiece with an improved time zone function that overcomes perceived deficiencies in the prior art and further achieves the objectives set forth herein.

### SUMMARY AND OBJECTIVES OF THE INVENTION

Accordingly, it is an objective of the present invention o provide an electronic device with an improved time zone feature and functionality.

For example, it is an objective to provide a timepiece with a time zone feature that has improved functionality and a reduction of mechanical complications thereby providing a timepiece that is more flexible, more user-friendly and that can provide more precise timekeeping.

For example, it is an objective to provide such a timepiece that provides for improved individual adjusting of desired time zones and/or for daylight saving time (DST).

Another objective is to provide such a timepiece that allows for an increased number of time zones available for selecting.

Yet another objective is to provide a world time timepiece that provides for the display of the many time zones in one location, e.g. through a window in a dial.

Still another objective is to provide a world time timepiece that provides for easier reading precision, for example, whereby an additional hand and 24-hour indications are provided on the dial to provide a second time-zone time indication.

In addition, the timepiece of the present invention has an improved construction because, for example, at least some of the mechanical features previously required in the bezel are now provided in the movement assembly itself.

Still other objects and advantages of the invention will in part be obvious and in part be apparent from this disclosure.

The invention accordingly comprises the features of construction, combination of elements, arrangement of parts and sequence of steps which will be exemplified in the construction, illustration and description hereinafter set forth, and the scope of the invention will be indicated in the claims.

Generally speaking, in accordance with the present invention, an improved wearable timepiece of the type wherein time zone information is conveyed by the use of at least one indicator rotateable about an axis is provided. In a preferred embodiment, the wearable timepiece comprises a dial assembly having a viewing window, wherein the dial assembly has a front side and a back side, and wherein the at least one indicator is positioned on the front side of the dial assembly, the wearable timepiece comprising a time zone indication assembly, positioned on the back side of the dial, comprising a first rotateable elongated member having a plurality of time zone indications thereon; a second rotateable elongated member that overlies at least part of the first elongated member, wherein the second elongated member has a plurality of time zone indications thereon, wherein at least one time zone indication on the first rotateable elongated member is positionable in the viewing window and at least one time zone indication on the second rotateable elongated member is positionable in the viewing window; an actuation assembly for at least rotating the first elongated member in at least one of a clockwise and counterclockwise direction and rotating the second elongated member in at least one of a clockwise and counterclockwise direction, wherein rotation of the first elongated member in the one of the clockwise and counterclockwise directions causes a subset of the plurality of time zone indications thereon to be positionable in the viewing window and rotation of the second elongated member in one of the clockwise and counterclockwise directions causes a subset of the plurality of time zone indications thereon to be positionable in the viewing window; wherein rotation of the first rotateable elongated member and the second rotateable elongated member causes different time zone indications on at least one of the first rotateable elongated member and second elongated member to be positionable in the viewing window; and rotating the at least one indicator in at least one of a clockwise and counterclockwise direction; and a controller, operatively coupled to the actuation assembly, tier controlling the rotation of the first and second elongated members and for causing the at least one indicator to rotate in response to a selected time zone indication positioned in the viewing window; wherein the indicator points to indicia on the dial assembly that indicates to a user the time indicated by the selected time zone indication.

In an alternative embodiment, the present invention is directed to a wearable timepiece of the type wherein time zone information is conveyed by the use of at least one indicator rotateable about an axis, the wearable timepiece comprising a dial assembly having a viewing window, wherein the dial assembly has a front side and a back side, and wherein the at least one indicator is positioned on the front side of the dial assembly, the wearable timepiece comprising a time zone indication assembly, positioned on the back side of the dial, comprising a rotateable elongated member having a plurality of time zone indications thereon, wherein at least one time zone indications on the rotateable elongated member is positionable in the viewing window; an actuation assembly for at least (i) rotating the elongated member in at least one of a clockwise and counterclockwise direction, wherein rotation of the elongated member in the one of the clockwise and counterclockwise directions causes a subset of the plurality of time zone indications thereon to be positionable in the viewing window, wherein rotation of the rotateable elongated member causes different time zone indications on the rotateable elongated member to be positionable in viewing window; and (ii) rotating the at least one indicator in at least one of a clockwise and counterclockwise direction; and a controller, operatively coupled to the actuation assembly, for controlling the rotation of the elongated member and for causing the at least one indicator to rotate in response to a selected time zone indication positioned in the viewing window; wherein the indicator points to indicia on the dial assembly that indicates to a user the time indicated by the selected time zone indication.

In yet a further embodiment, the present invention is directed to a method of indicating a time in a selected time zone, wherein the wearable timepiece is of the type wherein time zone information is conveyed by the use of at least one indicator rotateable about an axis, the wearable timepiece comprising a dial assembly having a viewing window, wherein the dial assembly has a front side and a back side, and wherein the at least one indicator is positioned on the front side of the dial assembly, the wearable timepiece further comprising a time zone indication assembly, positioned on the back side of the dial, comprising at least one rotateable elongated member having a plurality of time zone indications thereon, wherein at least one time zone indication on the at least one rotateable elongated member is positionable in the viewing window; an actuation assembly for at least (i) rotating the at least one elongated member in at least one of a clockwise and counterclockwise direction, wherein rotation of the at least one elongated member causes a subset of the plurality of time zone indications thereon to be positionable in the viewing window and rotation of the at least one rotateable elongated member causes different time zone indications on the at least one rotateable elongated member to be positionable in the viewing window; and (ii) rotating the at least one indicator in at least one of a clockwise and counterclockwise direction; and a controller, operatively coupled to the actuation assembly, for controlling the rotation of the at least one elongated member and for causing the at least one indicator to rotate in response to a selected time zone indication positionable in the viewing window; wherein the method comprises the steps of rotating the at least one elongated member until a desired time zone indication is positioned in the viewing window; selecting the desired time zone indication; and causing the at least one indicator to rotate in response to the selected time zone indication positioned in the viewing window; wherein the at least one indicator points to indicia on the dial assembly that indicates to a user the time indicated by the selected time zone indication.

In a preferred embodiment, the wearable timepiece is a wristwatch.

### BRIEF DESCRIPTION OF THE DRAWINGS

For a fuller understanding of the invention, reference is had to the following description taken in connection with the accompanying figures, in which:

FIGS. 1 and 2 are top plan views of a time zone display assembly, constructed in accordance with a preferred embodiment of the present invention, showing varying positions of the elongated members under the dial assembly;

FIGS. 3A and 3B illustrate exemplary first and second elongated members, respectively, in accordance with a preferred embodiment of the present invention;

FIG. 4 is a perspective cut-away view of the time zone display assembly of FIGS. 1 and 2, constructed in accordance with a preferred embodiment of the present invention;

FIG. 5 is a circuit diagram for a wearable timepiece constructed in accordance with a preferred embodiment of the present invention;

FIG. 6 is a block diagram of a controller for use in a wearable timepiece constructed in accordance with the present invention;

FIG. 7 is a top plan view of a time zone display assembly, constructed in accordance with another preferred embodiment of the present invention; and

FIG. 8 illustrates a wearable timepiece comprising any of the embodiments of the present invention.

Also, while not all elements are labeled in each figure, all elements with the same reference number indicate similar or identical parts.

### DETAILED DESCRIPTION OF HE PREFERRED EMBODIMENTS

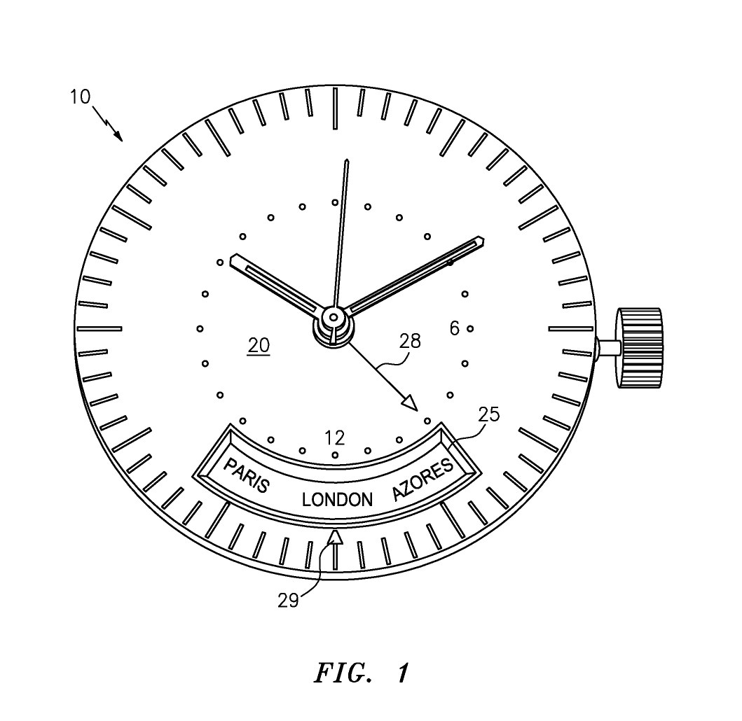

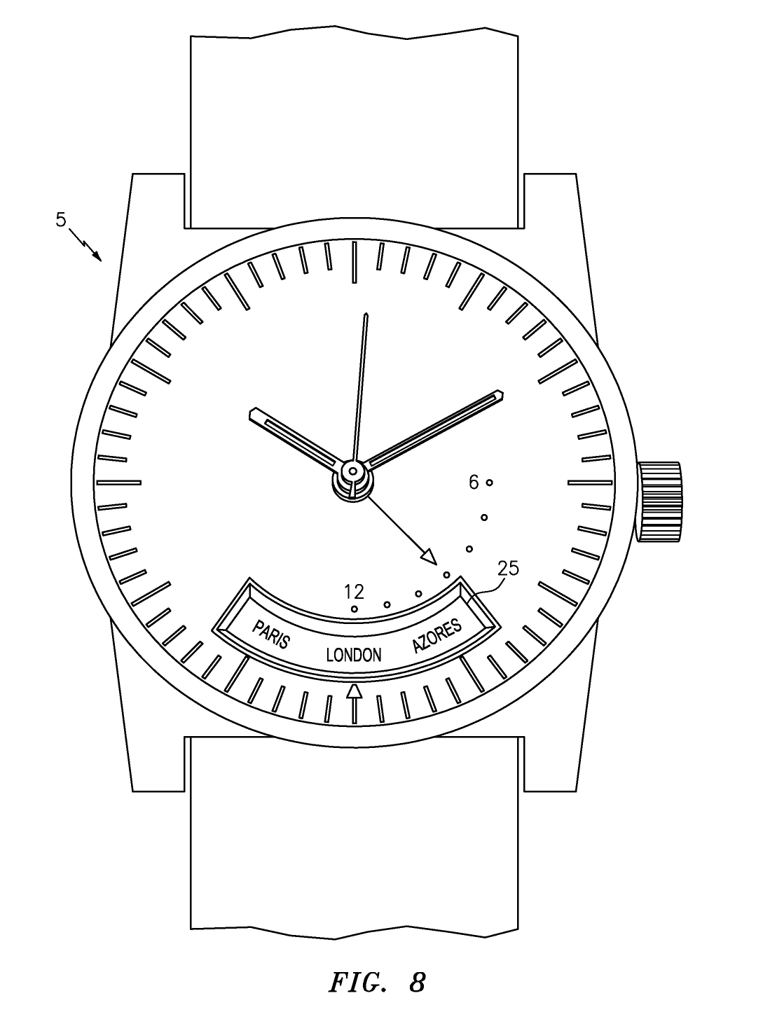

Reference is first made generally to FIGS. 1, 2 and 4, which illustrates a display assembly, generally indicated at 10, constructed in accordance with a first preferred embodiment of the present invention. In the preferred construction, display assembly 10 is part of an electronic device 5, which is preferably a wearable timepiece in general and a wristwatch in particular, as illustrated in FIG. 8. Constructing electronic device 5 with the particulars of display assembly 10, as disclosed herein, would be within the purview of one skilled in the art. Thus, electronic device 5 may comprise other features and parts not material to the present invention. Non-essential details of the present invention can be found in several patents, such as, for example and not limitation, U.S. Pat. No. 7,113,450, the subject matter thereof being fully incorporated by reference herein.

To carry out the foregoing objectives, the wearable timepiece of the present invention, and as illustrated in FIGS. 1, 2 and 4, comprise display assembly 10, which itself comprises a dial assembly 20, which preferably includes a dial, such as one made of brass, plastic, or the like, having a viewing window 25. The construction of a conventional dial and timekeeping functionality is well within the scope of the routinely skilled artisan.

Throughout, references are made to a “window 25” or the like. By reference, window 25 (or the like) is intended merely to indicate a designated area of dial assembly 20. That is, the current invention contemplates (and the claims are intended to cover) the idea that dial assembly 20 may be partially, mostly and/or completely transparent, even to the extent that many other time zone indications as discussed herein may be simultaneously visible. That is, reference to “window 25” (or the like) is merely to indicate that there is preferably a designated section (however small or large is one primarily of design choice) on the dial assembly for a user to quickly be able to ascertain what time zone is being selected or in close proximity (e.g. the next time zone) to the selected time zone. In a specific embodiment, window 25 may in fact be an actual opening in the dial or simply a transparent section in the dial.

Electronic device 5, and display assembly 10 in particular, further comprises at least one indicator 28 rotateable about an axis, for conveying time zone information as further discussed below. As illustrated, the dial assembly 20 has a front side and a back side, and the at least one indicator 28 is positioned on the front side of the dial assembly 20. The phrase “on the front side” (or “on the back side”) is not intended to mean that the indicator is physically “on” the dial, but rather simply as a reference point that is intended to mean more akin to “above” and/or “below” as the case may be.

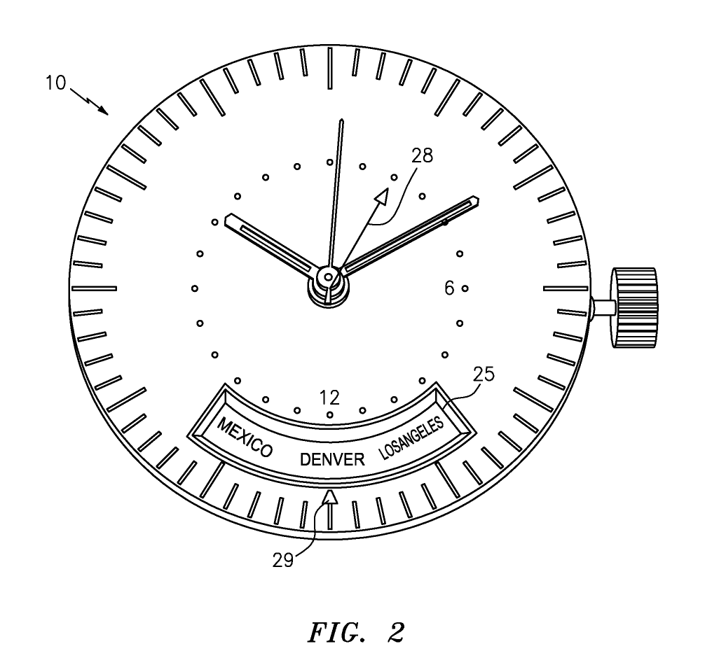

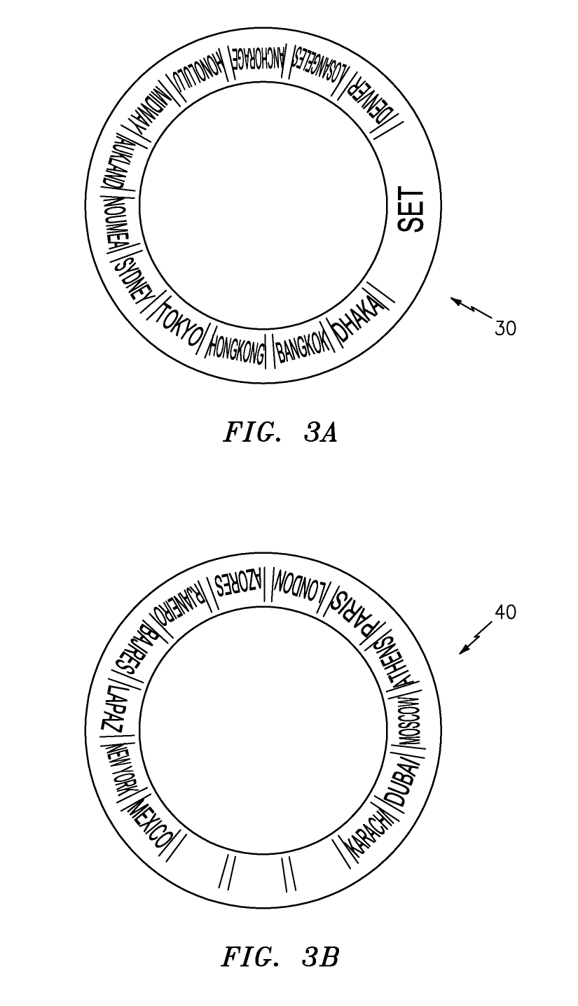

As such, electronic device 5 also comprises a time zone indication assembly, positioned on the back side of the dial. In a preferred embodiment, the time zone indication assembly comprises a first rotateable elongated member 30 having a plurality of time zone indications thereon (e.g. “DENVER,” “LOS ANGELES,” “ANCHORAGE,” etc. and others as illustrated in FIG. 3A) and a second rotateable elongated member 40 that overlies at least part of the first elongated member 30, wherein the second elongated member 40 has a plurality of time zone indications thereon (e.g. “KARACHI,” “DUBAI,” “MOSCOW,” etc. and others as illustrated in FIG. 3B) wherein at least one time zone indication on the first rotateable elongated member 30 is positionable so as to be visible in the viewing window 25 and at least one time zone indication on the second rotateable elongated member is positionable so as to be visible in the viewing window 25. Importantly however, it is not necessary nor required that there simultaneously be one time zone indication on the first rotateable elongated member 30 visible in the viewing window 25 and at least one time zone indication on the second rotateable elongated member visible in the viewing window 25. For example, in FIG. 1, the three time zone indicators are all from the second elongated member 40. On the other hand, merely by way of example, FIG. 2 illustrates one (1) time zone indication on the second rotateable elongated member 40 being visible in the viewing window along with two (2) time zone indicators from the first elongated member 30. Likewise, it is contemplated in practical use of electronic device 5 that all three (3) visible time zone indicators may be on the first elongated member 30. However, to be sure, the dial assembly may be of sufficient transparency that (e.g.) more than three (3) time zones may be simultaneously visible. However, what is important is that there is preferably an area designated on dial assembly where the desired time zone(s) being selected is/are more easily ascertainable. One such embodiment is with a designated “window” area. Moreover, herein, reference to the time zones being “visible” or “not visible” should be understood as simply being a preferred embodiment. Clearly for example, if the dial assembly is transparent, more than only the time zones in the “window” will be visible. So, reference to “visibility” or “non-visibility” should be understood as preferred embodiments and not limitations.

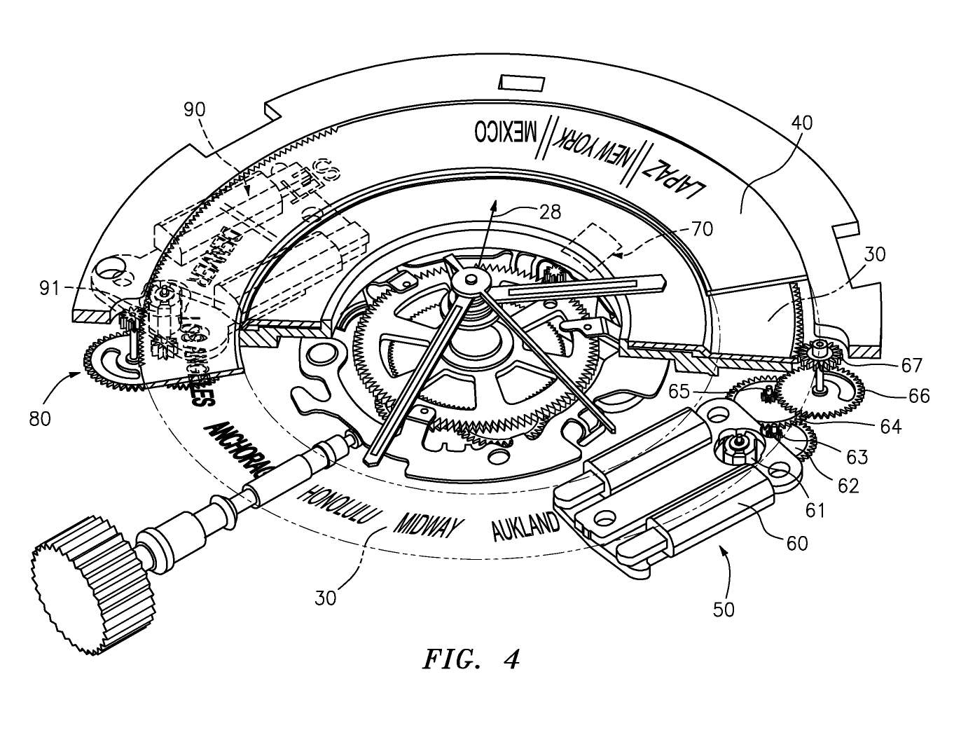

Electronic device 5 also includes an actuation assembly, which, in the preferred embodiment, comprises a plurality of stepper motors, for at least (i) rotating the first elongated member 30 in at least one of a clockwise and counterclockwise direction and rotating the second elongated member 40 in at least one of a clockwise and counterclockwise direction, wherein rotation of the first elongated member 30 in the one of the clockwise and counterclockwise directions causes a subset of the plurality of time zone indications thereon to be positionable (e.g. visible) in the viewing window 25 and rotation of the second elongated member 40 in one of the clockwise and counterclockwise directions causes a subset of the plurality of time zone indications thereon to be positionable (e.g. visible) in the viewing window 25; wherein rotation of the first rotateable elongated member and the second rotateable elongated member causes different time zone indications on at least one of the first rotateable elongated member 30 and second elongated member 40 to be positionable (e.g. visible) in the viewing window as exemplified in FIGS. 1 and 2; and (ii) rotating the at least one indicator 28 in at least one of a clockwise and counterclockwise direction. In this way, and as discussed in greater detail below, the actuation assembly provides for a first stepper motor 60 to rotate the first elongated member 30 in a clockwise and/or counterclockwise direction and a second stepper motor 90 for rotating the second elongated member 40 in at least a clockwise and/or counterclockwise direction, all so that selected time zone indicators on the respective elongated members 30 and 40 are movable into the window 25 so as to be visible or out of the window 25 (e,g. so as not to be visible, if desired). For example, FIG. 1 illustrates three (3) of the time zone indicators of elongated member 40 being visible in window 25 while FIG. 2 illustrates that at least second elongated member 40 has been rotated so as to make visible the “MEXICO” time zone indication as well as to permit the visibility of the “DENVER” and “LOS ANGELES” time zone indicators of the first elongated member 30. A third stepper motor, generally indicated at 70 (FIG. 4), rotates the at least one indicator 28 in at least one of a clockwise and counterclockwise direction, depending on the selected time zone indicator in the viewing window 25. For example, FIG. 1 illustrates indicator 28 indicating a time of 9:00 while indicator 28 in FIG. 2 illustrates a time of 2:00.

Controlling all the foregoing rotation is a controller, generally indicated at 100, and operatively coupled to the actuation assembly, for controlling the rotation of the first and second elongated members 30, 40 and for causing the at least one indicator 28 to rotate in response to a selected time zone indication positioned in (e,g. visible through) the viewing window 25. In this way, and with further details and examples being set forth below, indicator 28 points to indicia on the dial assembly that indicates to a user the time indicated by the selected time zone indication.

In a preferred embodiment, the opening in (or transparent portion of) the dial may provide for the visibility of three (3) time zones but this is by example and not limitation. Similarly, by example and not limitation, the elongated members 30, 40 of the preferred embodiment are each divided into fifteen (15) segments, but more or less segments are contemplated herein. Moreover, in a particularly preferred embodiment, elongated members 30 and 40 are rings, as illustrated in FIGS. 3A, 3B. As should be understood in the art, the foregoing two (2) ring embodiment enables sector angles per city of greater than (>) 15° (e.g. 360°/24 cities) or there can be more than 24 cities if desired.

As should now be understood, the position of second rotateable ring 40 overlying first rotateable ring 30 in viewing window 25 causes the viewability of differing sequences of time zones.

Turning to FIG. 4, and with respect to the first embodiment, the actuation assembly preferably comprises (i) a first assembly generally indicated at 50, comprising one or more wheels being meshingly coupled to first rotateable elongated member 30 so that the rotation of the one or more wheels causes the rotation of first rotateable elongated member 30 and a first stepper motor 60 comprising a rotor 61, wherein the rotor of stepper motor 60 is rotatably coupled to the at least one or more wheels, wherein the rotation of rotor 61 causes the rotation of first rotateable elongated member 30; and (ii) a second assembly generally indicated at 80, comprising one or more wheels being meshingly coupled to second rotateable elongated member 40 so that the rotation of the one or more wheels causes the movement of second rotateable elongated member 40 and a second stepper motor 90 comprising a rotor 91, wherein the rotor of stepper motor 90 is rotateably coupled to the at least one or more wheels, wherein the rotation of rotor 91 causes the rotation of second rotateable elongated member 40.

Although it is believed that the construction of the aforementioned first and second assemblies 50 and 80 are well within the purview of the skilled artisan, the following is set forth for completeness, with particular reference being made to assembly 50. Assembly 80 is constructed in a similar maimer.

Assembly 50 preferably comprises stepper motor 60 and the aforementioned one or more wheels operatively coupled to motor 60. Stepper motor 60, which is preferably a bi-directional motor, comprises rotor 61 that is rotateably coupled to at least a first of the wheels of the gearing assembly. That is, the rotor will preferably comprise teeth that meshingly align with the outer teeth of a first wheel 62. In turn, first wheel 62 includes a pinion 63 which itself has teeth that meshingly align with teeth on the outer circumference of a second wheel 64. Second wheel 64 comprises a pinion 65 which itself has teeth that meshingly align with teeth on the outer circumference of a third wheel 66. This third wheel 66 likewise comprises a pinion 67 which itself has teeth that meshingly align with teeth on the outer circumference of member 30. In this way, the rotation of rotor 61 of motor 60 can cause the rotation of member 30. It should be understood that the number of wheels and number of teeth on each wheel may be more or less (or different as the case may be) than that set forth herein, and are really one of design choice for the intended function and based upon a number of known criterions, such as power and torque constraints. The selection of a suitable stepper motor and the arrangement and/or positioning of the components are all within the purview of one skilled in the art. Likewise, members 30 and/or 40 may alternatively he driven by teeth on their inner circumference.

In a preferred embodiment, assemblies 50 and 80 are similarly constructed, so no further details of assembly 80 are needed or necessary.

It should be now be understood in view of the foregoing disclosure and FIGS. 1-4 that the time zones on the respective rotateable members that are not positioned within viewing window 25 are preferably not viewable, but as explained above, with a transparent dial other time zones may in fact be visible (but at least not selectable).

Nevertheless, to allow for the viewability of the time zones on the first elongated member 30, second elongated member preferably has at least three (3) translucent sections on which no time zones are printed to allow for the visibility of selected time zones on the underlying first elongated member 30.

As alluded to above, the at least one indicator 28 is preferably a display hand, and is used to point to the respective hour demarcations on the dial assembly 20, thus indicating the time in the selected time zone. Indicator 28, which is preferably rotateable about an axis (centered about the dial or otherwise), is also operatively coupled to an actuation mechanism, such as a stepper motor, which, along with a separate set of gearing, is generically indicated by reference number 70 in FIG. 4. This stepper motor rotates indicator 28 in at least one of a clockwise and counterclockwise direction. In this way, indicator 28 is used to indicate the time in the selected time zone. Details of a gear train and stepper motor that can be used to rotate indicator 28 should be well understood by those skilled in the art, as well as is fully disclosed in aforementioned U.S. Pat. No. 7,113,450.

In the preferred embodiments, motors 60, 70 and 90 are bi-directional stepper motors thus being able to rotate in either direction, and the construction of acceptable stepper motors to functionally operate in this manner are widely available and well within the understanding of those skilled in the art.

To provide the proper and accurate controlling, positioning and rotation of elongated members 30, 40 (as well as indicator 28), a controller is provided, details of which can be found in the aforementioned U.S. Pat. No. 7,113,450 patent as well as U.S. Pat. No. 7,120,091, the subject matter of which is also incorporated by reference as if fully set forth herein.

In the aforementioned '450 and/or '091 patent, with reference to controller 100 therein, the controller of the present invention preferably comprises all of the functional features described therein to carry out the objectives and features of the present invention. The functionality particular to the present invention shall now be disclosed.

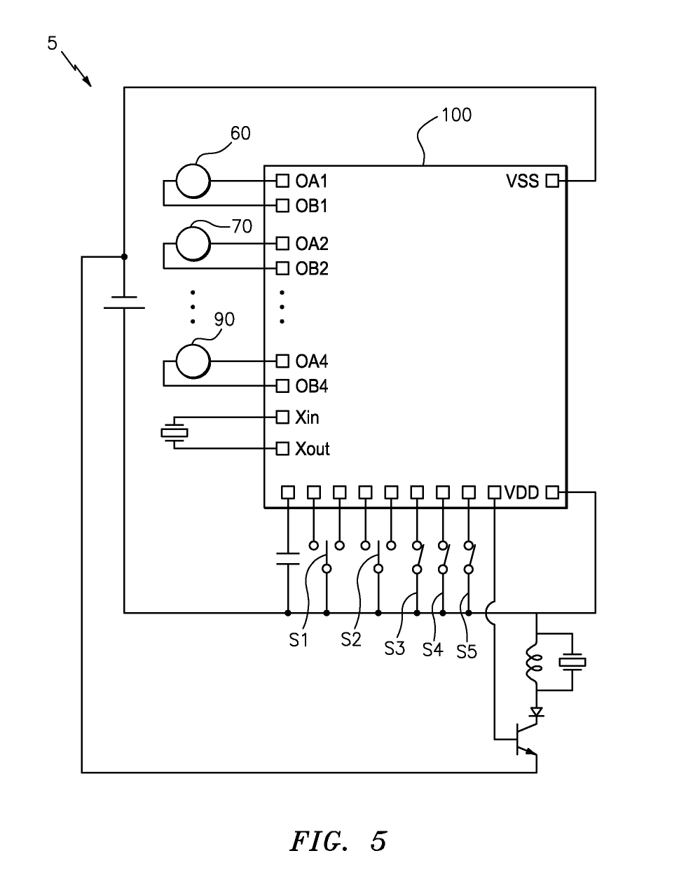

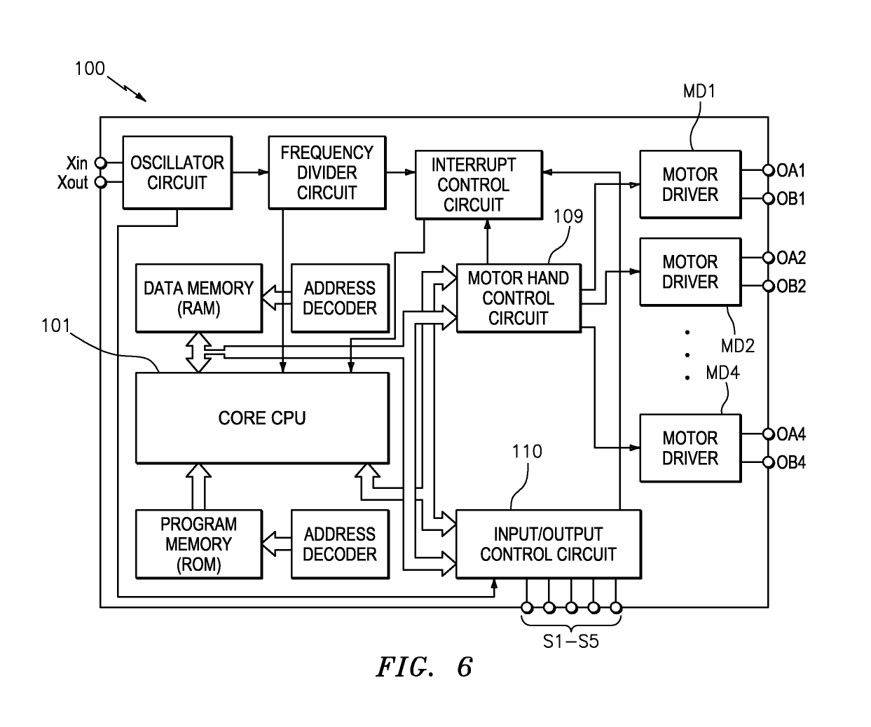

General reference may be made to FIG. 5 for a partial block diagram of electronic device 5, constructed in accordance with a preferred embodiment, which illustrates among other things, interface connections to motors 60, 70 and 90 (other motors may be provided, for the hour and minute hands, as would be understood in the art) and switches S1-S5. Switches S1-S5 are intended to generically indicate both side/top mounted pushers (herein referred to generically as “PB1”-“PB5”), as well as side mounted rotateable crowns, and thus respond to the actuation (i.e. pulling and/or pushing) action thereof. In the case of crowns and pushers, the pulling and or pushing actuations may be provided for setting the hour and minute hands and/or calibrating indicator 28 and/or calibrating and/or manually rotating members 30 and/or 40. If necessary, a preferred hand and disc calibration methodology and arrangement is disclosed in U.S. Pat. No. 7,266,051 the subject matter which is likewise incorporated by reference as if fully set forth herein. In this way, it is always possible to calibrate (i.e. initialize the position of) indicator 28 and/or members 30, 40 so that controller 100 knows their respective positions. As illustrated in FIG. 6, an input/output control circuit 110 controls the crown actuations and pushbutton switches and provides such signaling information to CPU 101.

Reference thus may also be made to FIG. 6, which illustrates a block diagram of controller 100. Particular reference is made to motor control circuit 109, which receives a commanded “next number of pulses” from CPU core 101 and generates the pulsed and phased signals necessary to move a desired motor (60, 70, 90) a desired amount and in a desired direction. Pulse outputs of motor control circuit 109 are buffered by motor drivers MD1, MD2, MD4 and applied to respective motors 60, 70, 90.

Although the preferred embodiment provides that controller 100 is highly integrated wherein all timing and display functionality is controlled in controller 100, alternate embodiments could separate the timekeeping functions from those processing and displaying stored or sensed data, as would be understood by one skilled in the art. In addition, known programming techniques, through software and/or switch actuation sequences if desired, are preferably used to program controller 100 so that it “knows” and or otherwise maintains, among other things, accurate time and time zone information. Such functionality and programming features are within the purview of one skilled in the art.

Known methodologies provide for the accurate rotation of indicator 28. For example, indicator 28 may rotate upon the detection of an elapsed 24 hour period or electronic signaling, as would he understood by those skilled in the art. In addition, well known programming techniques such as those described in the patents incorporated herein by reference set forth acceptable methodologies of ensuring proper, sufficient and accurate stepper of the stepper motor(s). Specifically, these known techniques allow controller 100 to determine whether and when to signal motor control circuit 109 to step the respective stepper motor so that a hand 28 or member 30 and/or 40 should rotate, and by how much.

Although variations are contemplated as to how to effectuate and sequence the rotation of the members 30, 40 and indicator 28, a preferred methodology is set forth herein.

At the outset, it is important to keep in mind that the preferred embodiments of the present invention provide that indicator 28 is not meshingly engaged with the standard hour hand and minute hand. In view thereof, the present configuration enables individual adjusting of desired time zones, including for daylight saving time (DST), as the DST is not linked/coupled to members 30, 40 in the preferred embodiments. Time adjustment is preferably done by correction of indicator 28 (e.g. by using pushers S1 (e.g. PB1) or S2 (e.g. PB2) as discussed below), after selection of the desired time zone. This methodology and configuration provides for more precise calibration and increased flexibility than the constructions in the prior art.

For example, the “wanted” time zone (e.g. city), which corresponds to the “selected” time zone, can be selected by actuation of a selected pusher PB1 (e.g. S1) so as to rotate the members 30, 40 in a first (e.g. clockwise) direction or by actuation of a selected pusher PB2 (e.g. S2) so as to rotate the members 30, 40 in a second (e.g. counterclockwise) direction. Since controller 100 maintains “knowledge” of the position of the members 30, 40, the controller can control the appropriate rotation of the elongated members (e.g. rings) so that the desired time zone can be selected. That is, one skilled in the art would recognize that it might be possible, advantageous and/or desirable that a first pusher may cause member 30 to rotate clockwise but cause member 40 to rotate counterclockwise, as such rotation could be used to make the rotations to a particular city more efficiently achieved. In a preferred embodiment, this will turn the members in steps (e.g. one push=one zone). The corresponding time to the city indicated will be indicated by indicator 28. This sequence may be repeated for selection of other time zones, wherein the indicator 28 will accordingly rotate to the proper time of the selected time zones. In the preferred embodiment, the city/zone selected will preferably be in the “center” of the window 25 or the three visible time zones, as the case may be. An indicator 29 (e.g. an arrow shown in FIGS. 1 and 2) may also be used for specifically pointing to the selected time zone.

In addition, and as illustrated in the Figures, three (3) segments are preferably provided on elongated member 30 (FIG. 3A) for allowing additional information (e.g. “SET”) to be displayed in window 25. For example, the time can be set for the wanted/selected time zone or adjusted if necessary to update controller 100 in the timepiece to changes, such as DST. This can be achieved by using, for example, one of the pushers PB3 (e.g. S3) to enter a “SET” menu while the time zone where time has to be adjusted is displayed in the center of window 25. The elongated members 30, 40 will turn and once the SET indicator is in the central position (e.g. SET MODE), time setting for indicator 28 can be done by pressing a pusher PB1 (e.g. S1) to rotate indicator 28 clockwise or a different pusher PB2 (e.g. S2) to rotate indicator counterclockwise. The SET MODE can then be exited by actuation of for example, pusher PB3 (e.g. S3) and the adjusted time zone appears again in window 25.

For example, from the foregoing it can be seen that there are several setting methodologies, although the two preferred ones are to be hereinafter disclosed.

For example, in a first embodiment, there is the setting of the UTC time zone. This can, for example, be done by the manufacturer or by the user/owner of the timepiece. In this embodiment, a person (or automated process) setting the timepiece will press the associated pusher PB″X″ until “SET” appears in the window 25. Then, using a preferably different associated pusher(s) (e.g. PB″Y″ for clockwise rotation and PB″Z″ for counterclockwise rotation), indicator 28 is rotated until the appropriate UTC time zone is indicated, with reference to the appropriate UTC offset. Then, the SET mode can be exited by actuation of a different or previously used pusher, as discussed above.

In an alternative preferred embodiment, one could begin by desiring the indication of “New York” time on indicator 28. Here, this is preferably done by first bringing the “New York” time zone into the window 25 as set forth above. Then, for example, after a time (e.g. 3 second) delay, the members 30, 40 are rotated again by actuation of an associated pusher until “SET” appears in the window 25. Then, using a preferably different associated pusher, indicator 28 may be rotated until the appropriate hour in New York is indicated by indicator 28. A final actuation of a selected pusher will cause the NY time zone to reappear in window 25 to correspond to the hour indicated by indicator 28.

In yet another alternative embodiment or simply as an additional feature, members 30, 40 could provide for multiple (i.e. two (2) positions) for each time zone to account for “summer” and “winter” time (i.e. DST). This could provide for even more user friendly setting and time indications.

It should also be noted that ½ hour time zones can also be programmed for indicator 28 if desired, and such ½ hour indicators may be provided therefor. Alternatively, a “double minute hand” or two such indicators 28 may be provided, for example, using two contrasting colors.

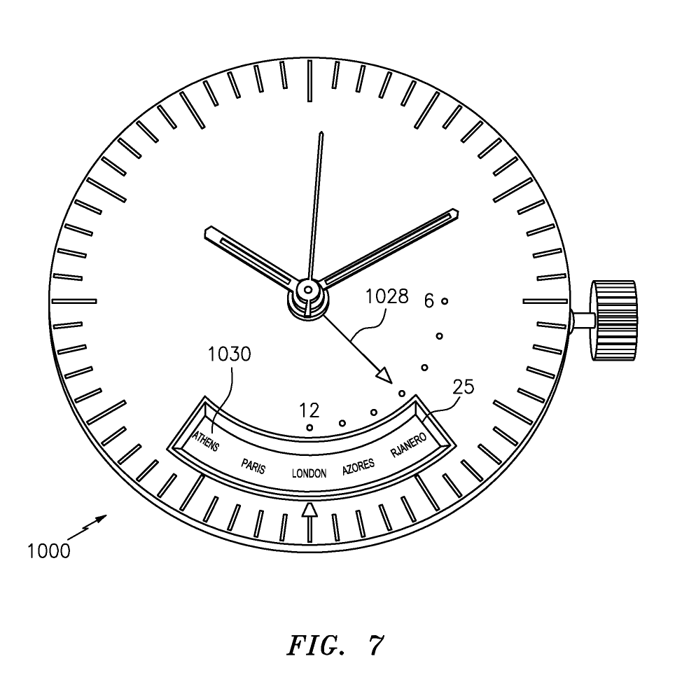

Reference is now made briefly to FIG. 7, which illustrates a display assembly, generally indicated at 1000, constructed in accordance with an alternative embodiment of the present invention. In this preferred construction, many features and functionality are identical to the embodiments disclosed above, with the key distinction being that there is only one elongated member, generally indicated at 1030. In this embodiment, all the time zone indicators are located on elongated member 1030. In all other respects however, the two embodiments function similarly.

For example, in this alternative embodiment, a stepper motor is provided to rotate elongated member 1030 in at least one of a clockwise and counterclockwise direction and at least a second stepper motor is provided to rotate the at least one indicator 1028 in at least one of a clockwise and counterclockwise direction. in all other similar ways, controller 100 is operatively coupled to the stepper motors of this alternative embodiment for controlling the rotation of elongated members 1030 and indicator 1028. As would be understood by those skilled in the art, a similarly constructed actuation assembly is provided for elongated member 1030 and indicator 1028. Here too, elongated member 1030 is preferably a ring and indicator 1028 is preferably a display hand. Controller 100 would equally be adapted to control the one elongated member 1030 and indicator 1028 as set forth above. The alternative features and embodiments for the display assembly are likewise applicable to this embodiment as well.

Similarly, in this alternative embodiment, the “wanted” (i.e. selected) time zone can be selected by actuation of a selected pusher PB1 (e.g. S1) to rotate members 1030 in a first (e.g. clockwise) direction or by actuation of a selected pusher PB2 (e.g. S2) to rotate member 1030 in a second (e.g. counterclockwise) direction. Likewise, the corresponding time to the city indicated will be indicated by indicator 1028.

In a similar manner, time can be set for the wanted/selected time zone (or adjusted if necessary to update controller 100 in the timepiece to changes, such as DST). This can be achieved by using, for example, one of the pushers PB3 (e.g. S3) to enter a “SET” menu while the time zone where time is desired to be adjusted may first be selected in the center of the window. Elongated member 1030 will turn and once the SET indicator is in the central position (e.g. SET MODE), time setting for indicator 1028 can be done by pressing a pusher PB1 (e.g. S1) to rotate indicator 1028 clockwise or a different pusher PB2 (e.g. S2) to rotate indicator counterclockwise. The SET MODE can then be exited by actuation of, for example, pusher PB3 (e.g. S3) and the adjusted time zone appears again in window 25. Similarly, the specific methodologies set forth above are equally applicable to this embodiment.

It will thus be seen that the present invention is both patentably different from and a significant improvement over known date displays. Specifically, the present invention provides a unique time zone feature that has improved functionality and a reduction of mechanical complications thereby providing a timepiece that is more flexible, more user-friendly and that can provide more precise timekeeping.

While the invention has been particularly shown and described with respect to preferred embodiments thereof, it will be understood that changes in form and details may be made therein without departing from the scope and spirit of the invention.

What claimed is:

1. A wearable timepiece of the type wherein time zone information is conveyed by the use of at least one indicator rotateable about an axis, the wearable timepiece comprising a dial assembly having a viewing window, wherein the dial assembly has a front side and a back side, and wherein the at least one indicator is positioned on the front side of the dial assembly, the wearable timepiece comprising:
a time zone indication assembly, positioned on the back side of the dial, comprising:
a first rotateable elongated member having a plurality of time zone indications thereon;
a second rotateable elongated member that overlies at least part of the first elongated member, wherein the second elongated member has a plurality of time zone indications thereon,
wherein at least one time zone indication on the first rotateable elongated member is positionable in the viewing window and at least one time zone indication on the second rotateable elongated member is positionable in the viewing window;
an actuation assembly for at least:
rotating the first elongated member in at least one of a clockwise and counterclockwise direction and rotating the second elongated member in at least one of a clockwise and counterclockwise direction, wherein rotation of the first elongated member in the one of the clockwise and counterclockwise directions causes a subset of the plurality of time zone indications thereon to be positionable in the viewing window and rotation of the second elongated member in one of the clockwise and counterclockwise directions causes a subset of the plurality of time zone indications thereon to be positionable in the viewing window; wherein rotation of the first rotateable elongated member and the second rotateable elongated member causes different time zone indications on at least one of the first rotateable elongated member and second elongated member to be positionable in the viewing window; and
rotating the at least one indicator in at least one of a clockwise and counterclockwise direction; and
a controller, operatively coupled to the actuation assembly, for controlling the rotation of the first and second elongated members and for causing the at least one indicator to rotate in response to a selected time zone indication positioned in the viewing window;
wherein the indicator points to indicia on the dial assembly that indicates o a user the time indicated by the selected time zone indication.

2. The wearable timepiece as claimed in claim 1, Wherein the overlying of the second rotateable elongated member over the first rotateable elongated member causes time zone indications of the first rotateable elongated member positioned in the viewing window to be non-viewable in the viewing window;
whereby the position of the second rotateable elongated member over the first rotateable elongated member in the viewing window causes the viewability of differing time zone indications in the viewing window.

3. The wearable timepiece as claimed in claim 1, wherein the actuation assembly comprises:
a first assembly comprising:
a first gearing assembly, comprising one or more gears, being meshingly coupled to the first rotateable elongated member so that the rotation of the one or more gears causes the rotation of the first rotateable elongated member; and
a first stepper motor comprising a rotor, wherein the rotor of the stepper motor is rotateably coupled to the at least one or more gears of the first gearing assembly, wherein the rotation of the rotor causes the rotation of the first rotateable elongated member; and
a second assembly comprising:
a second gearing assembly, comprising one or more gears, being meshingly coupled to the second rotateable elongated member so that the rotation of the one or more gears causes the movement of the second rotateable elongated member; and
a second stepper motor comprising a rotor, wherein the rotor of the stepper motor is rotateably coupled to the at least one or more gears of the second gearing assembly, wherein the rotation of the rotor causes the movement of the second rotateable elongated member.

4. The wearable timepiece as claimed in claim 1, wherein the time zone indications on the respective rotateable elongated members that are not positioned within the viewing window are not viewable in the viewing window.

5. The wearable timepiece as claimed in claim 4, wherein the viewing window is dimensioned to permit the viewability of at least three (3) time zone indications at any one time.

6. The wearable timepiece as claimed in claim 4, wherein the time zone indications on the respective rotateable elongated members that are not positioned within the viewing window are not viewable through the dial assembly.

7. The wearable timepiece as claimed in claim 1, wherein at least one of the first rotateable elongated member and the second rotateable elongated member is a ring.

8. The wearable timepiece as claimed in claim 1, wherein the viewing window is dimensioned to permit the viewability of at least three (3) time zone indications at any one time.

9. The wearable timepiece as claimed in claim 1, including a selector, operatively coupled to the controller, the actuation of which causes at least one of the first and second elongated members to rotate in the clockwise or counterclockwise direction so that a particular time zone indication is positionable in the viewing window and selectable.

10. The wearable timepiece as claimed in claim 9, wherein the controller, after the particular time zone indication is selected, causes the indicator to rotate in one of a clockwise and counterclockwise direction to indicate to a user the time in the region indicated by the selected time zone indicator.

11. The wearable timepiece as claimed in claim 1, wherein the timepiece is a wristwatch.

12. A wearable timepiece of the type wherein time zone information is conveyed by the use of at least one indicator rotateable about an axis, the wearable timepiece comprising a dial assembly having a viewing window, wherein the dial assembly has a front side and a back side, and wherein the at least one indicator is positioned on the front side of the dial assembly, the wearable timepiece comprising:
a time zone indication assembly, positioned on the back side of the dial, comprising a rotateable elongated member having a plurality of time zone indications thereon, wherein at least one time zone indications on the rotateable elongated member is positionable in the viewing window;
an actuation assembly for at least (i) rotating the elongated member in at least one of a clockwise and counterclockwise direction, wherein rotation of the elongated member in the one of the clockwise and counterclockwise directions causes a subset of the plurality of time zone indications thereon to be positionable in the viewing window, wherein rotation of the rotateable elongated member causes different time zone indications on the rotateable elongated member to be positionable in viewing window; and (ii) rotating the at least one indicator in at least one of a clockwise and counterclockwise direction; and
a controller, operatively coupled to the actuation assembly, for controlling the rotation of the elongated member and for causing the at least one indicator to rotate in response to a selected time zone indication positioned in the viewing window;
wherein the indicator points to indicia on the dial assembly that indicates to a user the time indicated by the selected time zone indication.

13. On a wearable timepiece, a method of indicating a time in a selected time zone, wherein the wearable timepiece is of the type wherein time zone information is conveyed by the use of at least one indicator rotateable about an axis, the wearable timepiece comprising a dial assembly having a viewing window, wherein the dial assembly has a front side and a back side, and wherein the at least one indicator is positioned on the front side of the dial assembly, the wearable timepiece further comprising a time zone indication assembly, positioned on the back side of the dial, comprising at least one rotateable elongated member having a plurality of time zone indications thereon, wherein at least one time zone indication on the at least one rotateable elongated member is positionable in the viewing window; an actuation assembly for at least (i) rotating the at least one elongated member in at least one of a clockwise and counterclockwise direction, wherein rotation of the at least one elongated member causes a subset of the plurality of time zone indications thereon to be positionable in the viewing window and rotation of the at least one rotateable elongated member causes different time zone indications on the at least one rotateable elongated member to be positionable in the viewing window; and (ii) rotating the at least one indicator in at least one of a clockwise and counterclockwise direction; and a controller, operatively coupled to the actuation assembly, for controlling the rotation of the at least one elongated member and for causing the at least one indicator to rotate in response to a selected time zone indication positionable in the viewing window; wherein the method comprises the steps of:
rotating the at least one elongated member until a desired time zone indication is positioned in the viewing window;
selecting the desired time zone indication; and
causing the at least one indicator to rotate in response to the selected time zone indication positioned in the viewing window;
wherein the at least one indicator points to indicia on the dial assembly that indicates to a user the time indicated by the selected time zone indication.
